(19) United States
(12) Patent Application Publication
(10) Pub. No.: US 2008/0018849 A1
(43) Pub. Date: Jan. 24, 2008

(54) Display element

(75) Inventor: Kazuaki Igarashi, Hakusan-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/822,819

(22) Filed: Jul. 10, 2007

(30) Foreign Application Priority Data
Jul. 11, 2006 (JP) 2006-190324

(51) Int. Cl. G02F 1/1345

(52) U.S. Cl. 349/149

(57) ABSTRACT

A right end portion of a power supply wiring located at the right end side of a bus wiring portion FPC, and a left end portion of a power supply bus wiring located at the left side of an interface portion FPC which is spaced from the right side of the bus wiring portion FPC so as to face the right side concerned are electrically connected to each other by an in-glass connecting bus wiring provided onto one principal surface of a mount portion of a glass substrate. A substrate portion can be divided into two FPCs, positioning can be facilitated, a press-fitting frequency can be reduced and the number of manufacturing steps can be reduced. The shapes of FPCs can be set to a simple shape such as a rectangular shape or the like, so that the number of FPCs which can be yielded can be enhanced, and the product cost can be suppressed.

### INCORPORATION BY REFERENCE

The present application claims priority under 35 U.S.C. §119 to Japanese Patent Application No. 2006-190324 filed on Jul. 11, 2006. The content of the application is incorporated herein by reference in its entirety.

### FIELD OF THE INVENTION

The present invention relates to a display element mounting a plurality of driving means for driving pixels on one principal surface of an insulating substrate.

### BACKGROUND OF THE INVENTION

Conventionally, in a liquid crystal panel corresponding to a liquid crystal display element as a display element is adopted a so-called COG (Chip On Glass) mounting in which an effective display portion having a plurality of pixels arranged in a matrix form is formed on a glass substrate as an insulating substrate, and a gate driver and a source driver corresponding to a plurality of driving ICs as driving means for driving the plurality of pixels are directly mounted along one side of the effective display portion.

For example, as disclosed in Japanese Laid-Open Patent Publication No. 9-288279, each driving IC is provided with a plurality of terminals such as power supply lines and signal lines, and press-fitted to a substrate having an external circuit at the end portion of the insulating substrate via anisotropic conductive film, that is, ACF (Anisotropic Conductive Film) via TCP (Tape Carrier Package) or FPC (Flexible Printed Circuit) at the portion corresponding to each driving IC.

In the liquid crystal panel adopting the COG mounting as described above, when a bus wiring is formed on the glass substrate to supply a signal and power to each driver, the bus wiring on the glass substrate has a high resistance value, and thus voltage drop occurs due to wiring resistance if the length of the power supply wiring is increased. Therefore, there is concern that the driving IC, in particular, the source driver in which a large amount of current flows malfunctions. For example, as described in Japanese Laid-Open Patent Publication No. 2005-114806, it is preferable that the length of the bus wiring on the glass substrate is suppressed and the electrical connection to the external circuit or the like is performed through a bus wiring having relatively small wiring resistance formed on the TCP or FPC.

However, in the above-described display element, as the resolution and reliability are higher, the press-fitting frequency of TCP or FPC is increased in accordance with the number of drivers to be mounted, and also it is not easy to perform the positioning between the glass substrate and TCP or FPC. Therefore, there is a problem that the number of manufacturing steps increases.

Furthermore, when the bus wiring as described above is formed on TCP or FPC, TCP or FPC having a complicated shape and a large area must be manufactured. The number of TCPs or FPCs which can be yielded is low and thus the product cost will increase.

The present invention has been implemented in view of the foregoing point, and has an object to provide a display element with which the number of manufacturing steps and the product cost are suppressed.

### SUMMARY OF THE INVENTION

The present invention is provided with an insulating substrate; a plurality of pixels provided on one principal surface of the insulating substrate; a plurality of driving means mounted on the one principal surface of the insulating substrate to drive the plurality of pixels; and a substrate portion for connecting these driving means to an external circuit, wherein the substrate portion includes a first substrate physically-connected to the one principal surface of the insulating substrate, a first wiring provided to the first substrate, one end portion thereof being located at one end side of the first substrate on the one principal surface of the insulating substrate and the other end portion thereof being electrically connected to the terminals of the driving means, a second substrate that is provided separately from the first substrate and physically connected to the one principal surface of the insulating substrate, one end side of the second substrate facing the one end side of the first substrate on the one principal surface of the insulating substrate so as to be spaced from the one end side of the first substrate, a second wiring that is provided to the second substrate, one end portion thereof being located at the one end side of the second substrate on the one principal surface of the insulating substrate and the other end portion being electrically connected to the external circuit, and an on-substrate wiring that is provided onto the one principal surface of the insulating substrate to electrically connect the one end portion of the first wiring and the one end portion of the second wiring. The one end portion of the first wiring located at the one end side of the first substrate and the one end portion of the second wiring located at the one end side of the second substrate which faces the one end side of the first substrate so as to be spaced from the one end side of the first substrate are electrically connected to each other through the on-substrate wiring provided onto the one principal surface of the insulating substrate, whereby the substrate portion can be divided into the first substrate and the second substrate, positioning can be facilitated and the frequency of press-fitting can be reduced. Therefore, the number of manufacturing steps can be reduced and the shapes of the first substrate and the second substrate can be simplified by dividing the substrate portion into the first substrate and the second substrate, so that the number of substrates which can be yielded can be enhanced, and also the product cost can be suppressed.

### BRIEF DESCRIPTION OF THE DRAWINGS

FIG. 1 is a plan view showing a part of a display element according to a first embodiment of the present invention;

FIG. 2 is a plan view showing a main part of the display element while enlarging the main part;

FIG. 3 is a plan view showing a part of a display element according to a second embodiment of the present invention; and

FIG. 4 is a plan view showing a main part of the display element while enlarging the main part.

### DETAILED DESCRIPTION OF THE PREFERRED EMBODIMENT

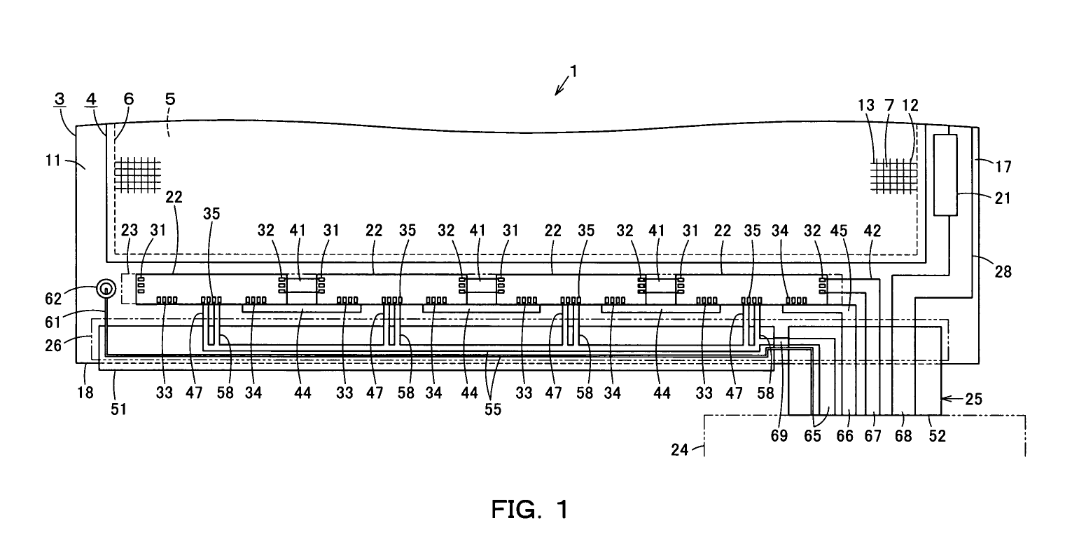

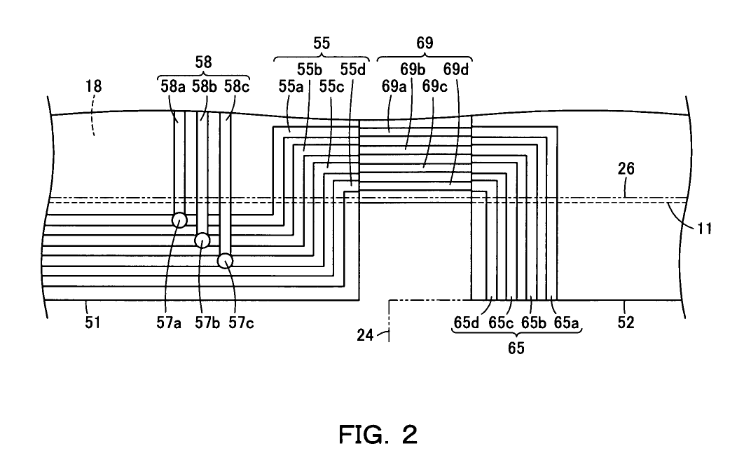

The construction of a display element according to a first embodiment of the present invention will be described with reference to FIG. 1 and FIG. 2.

In FIG. 1, 1 represents a liquid crystal panel corresponding to an active matrix type liquid crystal display element as a display element, and the liquid crystal panel 1 has an array substrate 3 and a counter substrate 4 which are disposed so as to face each other, and a liquid crystal layer 5 sandwiched and held between the array substrate 3 and the counter substrate 4. A rectangular effective display portion 6 serving as an image display area in which an image can be displayed is provided at the center portion of the liquid crystal panel 1. A plurality of pixels 7 are arranged in a matrix form along longitudinal and lateral directions of the liquid crystal panel 1 in the effective display portion 6. Furthermore, in the liquid crystal panel 1, the array substrate 3 and the counter substrate 4 are attached to each other by sealing agent (not shown) so that a liquid crystal layer 5 formed of a liquid crystal composition as an optical modulation layer is held via orientation films (not shown) between the array substrate 3 and the counter substrate 4. Polarizing plates (not shown) are disposed on the outer surfaces located at the outside of the array substrate 3 and the counter substrate 4 so that the polarization axes thereof are orthogonal to each other.

The array substrate 3 is equipped with a glass substrate 11 as an insulating substrate having translucency, and gate lines 12 as scan lines and source lines 13 as signal lines (only parts thereof are illustrated) are disposed on the inner surface of the one principal surface of the glass substrate 11 so as to be substantially orthogonal to each other. Furthermore, pixels 7 of the effective display portion 6 are located in respective areas which are partitioned and surrounded by the gate lines 12 and the source lines 13. Furthermore, each of these pixels 7 is provided with a thin film transistor (TFT) (not shown) as a switching element and a pixel electrode. The pixel electrode is electrically connected to the thin film transistor in the same pixel 7, and controlled by this thin film transistor.

Furthermore, in the glass substrate 11, portions projecting from the effective display portion 6 of the liquid crystal panel 1 in rightward and downward directions shown in FIG. 1 serve as mount portions 17 and 18 corresponding to the frame portions as slender rectangular COG portions.

A plurality of gate drivers 21 (only a part of them is shown) corresponding to gate line driving ICs as driving means for driving the pixels 7 of the effective display portion 6 of the liquid crystal panel 1 and displaying an image are successively mounted on the surface of the mount portion 17 along one end side of the glass substrate 11 at the right side of the figure of the effective display portion 6. Furthermore, plural, for example, four source drivers 22 which are source line driving ICs as driving means for driving the pixels 7 of the effective display portion 6 of the liquid crystal panel 1 and displaying an image are successively mounted on the surface of the mount portion 18 along an end side adjacent to the one end side of the glass substrate 11 at the lower side of the figure of the effective display portion 6. These drivers 21 and 22 are directly mounted via anisotropic conductive film 23 (herein after referred to as ACF (Anisotropic Conductive Film) 23) on the surface of the mount portions 17 and 18 of the glass substrate 11 and a COG (Chip On Glass) is mounted. Furthermore, a substrate portion 25 for supplying signals and power from an external circuit 24 to the drivers 21 and 22 are mounted on the mount portion 18 via anisotropic conductive film 26 (hereinafter referred to as ACF 26).

The respective gate drivers 21 are disposed along the up-and-down direction in the figure of the glass substrate 11, and every plural gate lines 12 are electrically connected to each gate driver 21. The signals/power are supplied from the external circuit 24 to the gate drivers 21 through in-glass bus wirings 28 as insulating substrate wirings formed on the surface of the glass substrate 11 and the substrate portion 25 over the mount portion 17 and the mount portion 18.

The respective source drivers 22 are designed in a slender rectangular shape, and disposed in a substantially linear elongated shape along the right-and-left direction of the figure of the glass substrate 11. Each of the source drivers 22 is provided with an output bump 31 as an output terminal and an input bump 32 as an input terminal at both end portions in the longitudinal direction, that is, at the end portions in the right-and-left sides in the figure, and a connection output bump 33 as a connection output terminal, a connection input bump 34 as a connection input terminal and a bump 35 as a terminal are provided at the opposite side to the effective display portion 6 as one end portion in the short-side direction, that is, at the lower end portion of the figure. Furthermore, a plurality of source line bumps (not shown) as signal line connection terminals which are electrically connected to the respective source lines 13 are provided at the effective display portion 6 side as the other end portion in the short-side direction, that is, at the upper end portion in the figure.

The bumps 31 and 32 are terminals supplied with a reference voltage from the external circuit 24 via the substrate portion 25, and it is electrically connected to the input bump 32 of the adjacent source driver 22 by an in-glass bus wiring 41 as an on-substrate connection wiring, and the input bump 32 of the source driver 22 at the right end portion in the figure is electrically connected to the substrate portion 25 by the in-glass bus wiring 42 as the on-substrate connection wiring formed on the surface of the glass substrate 11 at the mount portion 18. All source drivers 22 are electrically connected to one another in a serial cascade connection manner by the in-glass bus wiring 42, the input bump 32, the output bump 31, the in-glass bus wiring 41, the input bump 32, . . . , the output bump 31, the in-glass bus wiring 41, and the input bump 32.

The in-glass bus wiring 41 is formed linearly in the right-and-left direction of the figure between the adjacent source drivers 22 and 22.

The in-glass bus wiring 42 is formed at the mount portion 18 in an L-shape in a plan view from the substrate portion 25 to the input bump 32 of the source driver 22 located at the right end portion of the figure.

The bumps 33 and 34 are terminals supplied with signals of the source drivers 22 from the external circuit 24 via the substrate portion 25, and the bumps 33 and 34 of the adjacent source drivers 22 are electrically connected to each other by the in-glass bus wiring 44 as the on-substrate connection wiring, and the connection input bump 34 of the source driver at the right end portion of the figure is electrically connected to the substrate portion 25 by the in-glass bus wiring 45 as the on-substrate connection wiring formed on the surface of the glass substrate 11 at the mount portion 18. All source drivers 22 are cascade-connected to one another by the in-glass bus wiring 45, the connection input bump 34, the connection output bump 33, the in-glass bus wiring 45, the connection input bumps 34, . . . , the in-glass bus wiring 44 and the connection input bump 34.

The in-glass bus wiring 44 is formed linearly along the up-and-down direction of the figure.

The in-glass bus wiring 45 is formed at the mount portion 18 in an L-shape in a plan view from the substrate portion 25 to the connection input bump 34 of the source driver 22 located at the right end portion of the figure.

The bump 35 is a terminal supplied with each kind of power from the external circuit 24 via the substrate portion 25, and all source drivers 22 are electrically connected to the substrate portion 25 in parallel by the in-glass bus wiring 47 as the on-substrate connection wiring formed at the mount portion 18.

The in-glass bus wiring 47 is formed substantially linearly along the lower end side of the figure of the adjacent source drivers 22 and 22.

The substrate portion 25 has a bus wiring portion FPC (Flexible Printed Circuit) 51 as a first substrate and an interface portion FPC 52 as a second substrate, and FPCs 51 and 52 are physically connected onto the mount portion 18 by ACF 26.

The bus wiring portion FPC 51 is formed in an elongated flat rectangular shape in the right-and-left direction from the position corresponding to the source driver 22 located at the leftmost end of the figure to the position corresponding to the source driver 22 located at the rightmost end. The surface at the glass substrate 11 side of the upper portion of the figure serves as a one-side press-fitting portion by ACF 26, and the other portion serves as a double-layered wire portion. The bus wiring portion FPC 51 is provided with a power supply wiring 55 as a first wiring along the right-and-left direction of the figure. The power supply wiring 55 supplies power to each source driver 22. For example, as shown in FIG. 2, it has an earth line 55a for a ground (GND), an analog power supply line 55b for an analog power source (AVDD), a logic power supply line 55c for a logic power source (DVDD), and a common potential line 55d for a common potential (VCOM), and these lines 55a to 55d are formed substantially in parallel.

Here, these lines 55a to 55d are formed of copper foil or the like, and on the mount portion 18 of the glass substrate 11, each one end portion thereof is continuous with the right end portion of FIG. 2 corresponding to one end side of the bus wiring portion FPC 51. The lines 55a, 55b, and 55c are electrically connected to branch lines 58a, 58b, and 58c (these lines will be referred to as branch line 58) via through holes 57a, 57b, and 57c at predetermined positions, and each branch line 58 is provided so as to extend upwardly in the figure, and electrically connected to the in-glass bus wiring 47 shown in FIG. 1. Accordingly, the power supply wiring 55 is electrically connected to the bump 35 of the source driver 22 via the in-glass bus wiring 47. Furthermore, the common potential wire 55d is designed so that the left end portion of FIG. 1 corresponding to the other end portion thereof is bent upwardly in the figure, and electrically connected to an in-glass bus wiring 61 provided on the mount portion 18. The in-glass bus wiring 61 is electrically connected to the common potential terminal 62.

The interface portion FPC 52 is a portion as an interface for connecting the liquid crystal panel 1 and the external circuit 24. It is formed in a flat rectangular shape separately from the bus wiring portion FPC 51, and it is mounted on the mount portion 18 so that one end side thereof, that is, the left side shown in the figures is spaced from the right side shown in the figure of the bus wiring portion FPC 51 so as to face the right side concerned. On this interface portion FPC 52, a power supply bus wiring 65 as a second wiring is formed of copper foil or the like and formed in an L-shape so that one end portion thereof is located at the left side shown in the figure, and the other end portion is electrically connected to the external circuit 24. Bus wirings 66, 67, and 68 which are electrically connected to the in-glass bus wirings 45, 42, and 28 respectively are linearly formed of copper foil or the like at the side of the power supply bus wiring 65.

The power supply bus wiring 65 supplies power from the external circuit 24 to each source driver 22, and it has, for example, as shown in FIG. 2, an earth wiring 65a for a ground (GND), an analog power supply wiring 65b for an analog power source (AVDD), a logic power supply wiring 65c for a logic power source (DVDD) and a common potential wiring 65d for a common potential (VCOM). These wirings 65a to 65d are formed substantially in parallel to one another. The power supply bus wiring 65 is electrically connected by an in-glass connection bus wiring 69 as an on-substrate wiring formed between FPCs 51 and 52 at the mount portion 18.

The in-glass connection bus wiring 69 is formed over the area from the right side of the figure to the left side of the interface portion FPC 52 in the bus wiring portion FPC 51 so as to have a linear shape perpendicular to these right and left sides, that is, so as to connect the FPCs 51 and 52 by the shortest distance. The in-glass connection bus wiring 69 has connection bus wirings 69a, 69b, 69c, and 69d corresponding to the lines 55a, 55b, 55c, and 55d and the wirings 65a, 65b, 65c, and 65d. These connection bus wirings 69a to 69d are formed substantially in parallel to one another. Furthermore, the left end portion shown in the figure as the other end portions of these connection bus wirings 69a to 69d are electrically connected to the lines 55a to 55d of the power supply wirings 55 of the bus wiring portion FPC 51.

The bus wirings 66 to 68 are designed so that the other end portions thereof, that is, the lower end portions shown in the figure electrically connected to the external circuit 24, and the signals of the source drivers 22, a reference voltage and the signals/power of the gate drivers 21 are input from the external circuit 24.

Next, the assembling operation of the first embodiment described above will be described.

The array substrate 3 on which various kinds of films are formed and the counter substrate 4 are faced to each other and then attached to each other by sealing agent so as to be spaced from each other at a predetermined interval. Thereafter, liquid crystal material is sealingly filled between the substrates 3 and 4 to form a liquid crystal layer 5.

Thereafter, the gate drivers 21 are press-fitted and mounted via ACF (not shown) to predetermined positions of the mount portion 17 on which the in-glass bus wiring 28, etc., are formed while the in-glass bus wiring 28 and the bump are positioned to each other, and also the source drivers 22 are press-fitted and mounted via ACF 23 to predetermined positions of the mount portion 18 on which the respective wirings 41, 42, 44, 45, 47, 61, and 69 are formed while the in-glass bus wirings 41, 42, 44, 45, and 47 and the respective bumps 31 to 35 are positioned to each other.

Furthermore, the respective FPCs 51 and 52 are press-fitted and physically connected onto the surface of the mount portion 18 via ACF 26 while the respective wirings 28, 42, 45, 47, and 69 and the wirings 68, 67, 66, 65, and 58 are positioned to one another.

At this time, the power supply wiring 55 of the bus wiring portion FPC 51 and the power supply bus wiring 65 of the interface portion FPC 52 are electrically connected to each other via the in-glass connection bus wiring 69, and the common potential wiring 55d is electrically connected to the common potential terminal 62 via the in-glass bus wiring 61.

As described above, according to the first embodiment, the right end portion of the power supply wiring 55 located at the right end side of the bus wiring portion FPC 51 and the left end portion of the power supply bus wiring 65 located at the left side of the interface portion FPC 52 which is spaced from the right side of the bus wiring portion FPC 51 so as to face the right side concerned are electrically connected to each other by the in-glass connection bus wiring 69 provided to the one principal surface of the mount portion 18 of the glass substrate 11, whereby the substrate portion 25 can be divided into two FPCs 51 and 52, and also the positioning can be facilitated. Therefore, the press-fitting frequency can be reduced, and also the number of manufacturing steps can be reduced. In addition, the respective shapes of FPCS 51 and 52 may be set to a simple shape such as a rectangular shape or the like, and thus a wasted portion can be prevented from occurring when these FPCs 51 and 52 are taken out from the same area, and thus the number of FPCs which can be yielded can be enhanced, so that the unit cost of FPCs 51 and 52 can be reduced and the product cost can be reduced.

That is, with respect to the liquid crystal panel in which the source drivers are cascade-connected to one another, wiring is required between respective source drivers. Therefore, as the resolution and reliability of the liquid crystal panel are higher, the number of FPCs is larger and the press-fitting frequency is higher, so that the positioning is complicated and the number of manufacturing steps is increased. If these FPCs are integrally formed, the shape of FPC is complicated like a T-shape, L-shape or the like, and the number of FPCs which can be yielded decreases. On the other hand, according to the present embodiment, the substrate portion 25 can be constructed by only FPCs 51 and 52 having a simple shape, and thus the number of panels which can be yielded can be increased with reducing the number of manufacturing steps.

In particular, not only the bus wiring portion FPC 51, but also the various kinds of wirings from the gate driver 21 side concentrate on to the interface portion FPC 52. Therefore, it is not easy to make the interface portion FPC 52 coincident in shape with the bus wiring portion FPC 51, and thus the shape of each of FPCs 51 and 52 can be more securely simplified by separating the interface portion FPC 52 with respect to the bus wiring portion FPC 51.

Furthermore, the power supply wiring 55 and the power supply bus wiring 65 are connected to the right side of the bus wiring portion FPC 51 and the left side of the interface portion FPC 52 by the linear in-glass connecting bus wiring 69 vertical to them, that is, the power supply wiring 55 and the power supply bus wiring 65 are bypass-wired to each other via the in-glass connecting bus wiring 69 by the shortest distance, whereby the resistance value of the in-glass connecting bus wiring 69 can be suppressed to the minimum level, and the voltage drop caused by the in-glass connecting bus wiring 69 having a relatively large resistance value can be suppressed, so that the malfunction caused by this voltage effect can be prevented.

In particular, a large current value flows in the source drivers 22 as compared with the gate drivers 21, and thus the voltage drop is liable to occur via the in-glass connecting bus wiring 69. Therefore, by minimizing the length of the in-glass connecting bus wiring 69 to the shortest, the voltage drop of the power source to be supplied to the source drivers 22 can be suppressed, the malfunction of the liquid crystal panel 1 can be prevented, and the reliability can be enhanced.

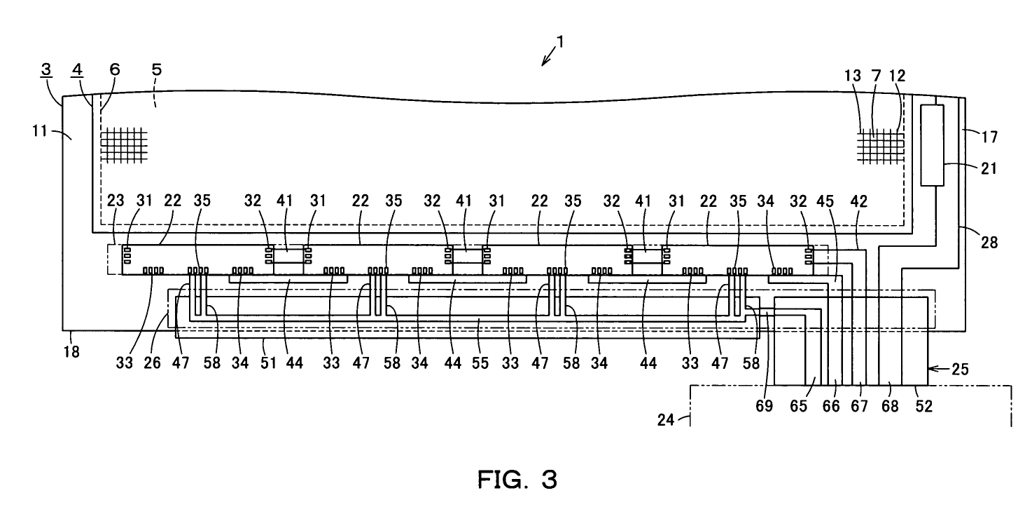

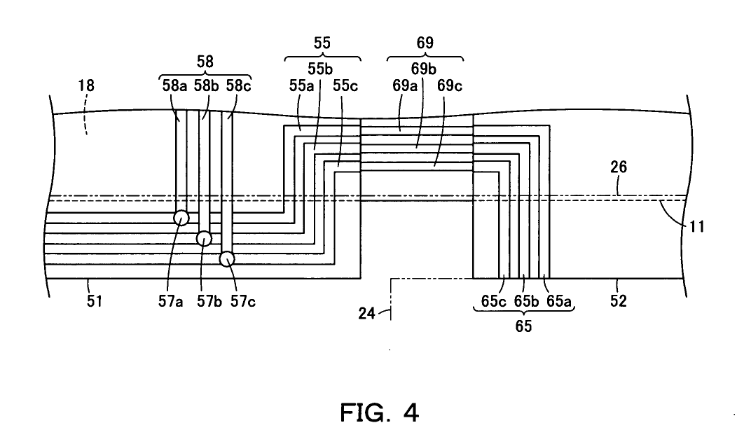

In the first embodiment, the same operation and effect as the second embodiment shown in FIG. 3 and FIG. 4 can be achieved by applying the same construction as the first embodiment to the liquid crystal panel 1 in which the common potential terminal 62, the common potential wire 55d and the in-glass bus wiring 61 are not provided.

Furthermore, details of the liquid crystal panel 1 such as the number of the power supply wirings, the number of the source drivers 22, etc., are not limited to those of the above construction.

Still furthermore, various display elements such as an organic EL display element or the like may be applied as the display element in place of the liquid crystal panel 1.

With respect to FPC of this embodiment, the double-layered FPC containing a through hole has been described as an example of four source drivers. However, if the number of the source drivers is smaller like two or the like, it can be easily analogized that a single-layered FPC containing no through hole may be used.

Furthermore, in this embodiment, two kinds of FPC are described. If an L-shaped wiring of this embodiment is used, it is obvious that a plurality of FPCs can be likewise connected.

What is claimed is:

1. A display element comprising:
an insulating substrate;
a plurality of pixels provided on one principal surface of the insulating substrate;
a plurality of driving means mounted on the one principal surface of the insulating substrate to drive the plurality of pixels; and
a substrate portion for connecting these driving means to an external circuit, wherein the substrate portion includes a first substrate physically-connected to the one principal surface of the insulating substrate, a first wiring provided to the first substrate, one end portion thereof being located at one end side of the first substrate on the one principal surface of the insulating substrate and the other end portion thereof being electrically connected to the terminals of the driving means, a second substrate that is provided separately from the first substrate and physically connected to the one principal surface of the insulating substrate, one end side of the second substrate facing the one end side of the first substrate on the one principal surface of the insulating substrate so as to be spaced from the one end side of the first substrate, a second wiring that is provided to the second substrate, one end portion thereof being located at one end side of the second substrate on the one principal surface of the insulating substrate and the other end portion being electrically connected to the external circuit, and an on-substrate wiring that is provided onto the one principal surface of the insulating substrate to electrically connect the one end portion of the first wiring and the one end portion of the second wiring.

2. The display element according to claim 1, wherein the on-substrate wiring is designed in a linear shape so as to be vertical to the one end side of the first substrate and the one end side of the second substrate.

3. The display element according to claim 1, wherein the insulating substrate includes scan lines and signal lines crossing each other, the pixels being disposed at the respective cross positions, and the driving means are source line driving ICs for driving the pixels via the signal lines.

4. The display element according to claim 3, wherein the first wiring and the second wiring are power supply wirings for supplying power from the external circuit to the source line driving ICs.

5. The display element according to claim 1 comprising:
an array substrate having the insulating substrate, the driving means and the substrate portion;
a counter substrate disposed so as to face the array substrate; and
a liquid crystal layer held between the array substrate and the counter substrate.
